(19) United States
(12) Patent Application Publication
(10) Pub. No.: US 2009/0047196 A1
(43) Pub. Date: Feb. 19, 2009

(54) SYSTEM FOR DYEING AN ARTIFICIAL RATTAN

(76) Inventor: Chuan-Kuei Hou, Taipei Hsien (TW)

Correspondence Address: CHRISTIE, PARKER & HALE, LLP, PO BOX 7068, PASADENA, CA, 91109-7068, US

(21) Appl. No.: 11/840,151

(22) Filed: Aug. 16, 2007

(51) Int. Cl. B05C 3/02

(52) U.S. Cl. 422/301

(57) ABSTRACT

A system for dyeing an artificial rattan includes: a feed spool for supplying the artificial rattan; a product spool for storing the artificial rattan; a dyeing unit including a dyeing bath for dyeing the artificial rattan with a dye material; a rubbing member disposed downstream of the dyeing unit for rubbing uniformly the dye material on the artificial rattan; a drying unit disposed downstream of the rubbing member for drying the dye material on the artificial rattan; and a conveying unit for drawing the artificial rattan from the feed spool, transporting the artificial rattan to pass through the dyeing unit, the rubbing member, and the drying unit, and delivering the dyed artificial rattan to the product spool.

### BACKGROUND OF THE INVENTION

1. Field of the Invention

The invention relates to a system for dyeing an artificial rattan, more particularly to a system using a conveying unit for transporting an artificial rattan through a dyeing bath.

2. Description of the Related Art

Conventionally, artificial rattans are dyed manually using a spraying tool and are subsequently rubbed manually in order to obtain a uniform dye layer on the artificial rattans, which can cause environmental and health problems, which can cause difficulty in controlling the quality of the product, and which can incur higher manufacturing costs.

### SUMMARY OF THE INVENTION

Therefore, the object of the present invention is to provide a system for dyeing an artificial rattan that can overcome the aforesaid drawbacks of the prior art.

According to the present invention, there is provided a system for dyeing an artificial rattan. The system comprises: a feed spool for supplying the artificial rattan; a product spool for storing the artificial rattan; a dyeing unit including a dyeing bath for dyeing the artificial rattan with a dye material; a rubbing member disposed downstream of the dyeing unit for rubbing uniformly the dye material on the artificial rattan; a drying unit disposed downstream of the rubbing member for drying the dye material on the artificial rattan; and a conveying unit for drawing the artificial rattan from the feed spool, transporting the artificial rattan to pass through the dyeing unit, the rubbing member, and the drying unit, and delivering the dyed artificial rattan to the product spool.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of the preferred embodiment of a system for dyeing an artificial rattan according to this invention; and

FIG. 2 is a fragmentary schematic view to illustrate how the artificial rattan is pressed into a dyeing bath of the preferred embodiment.

### DETAILED DESCRIPTION OF THE PREFERRED EMBODIMENT

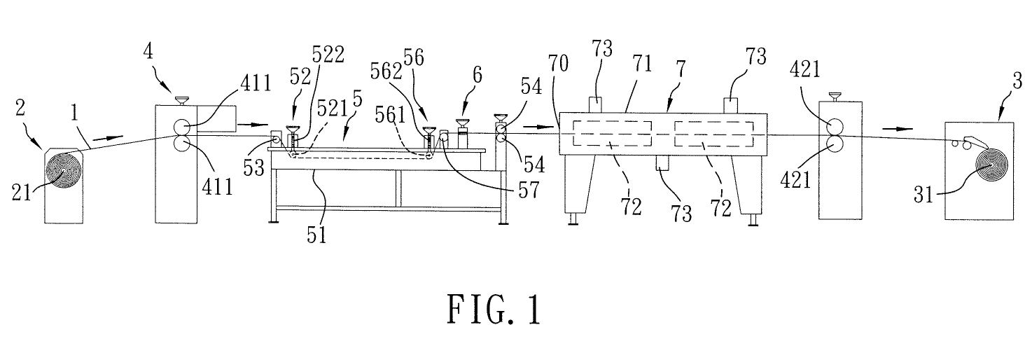

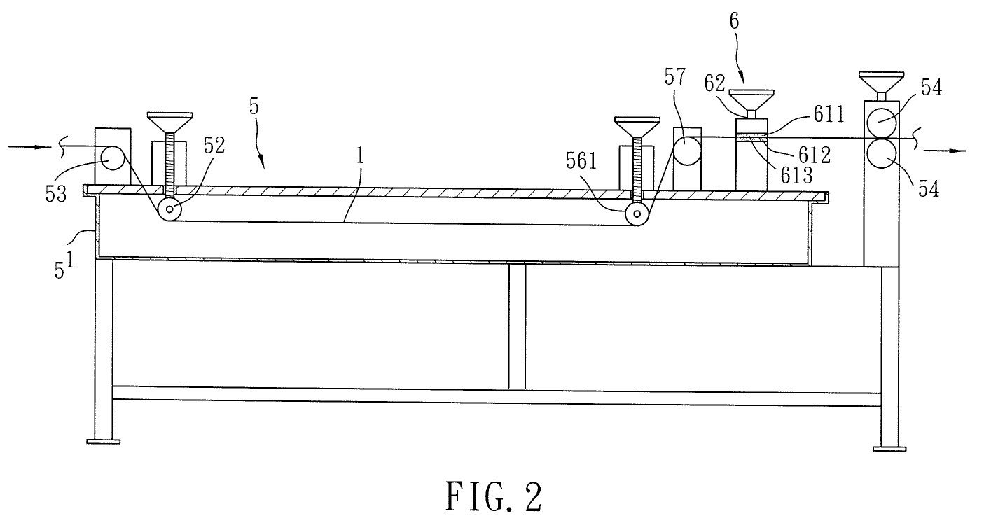

FIGS. 1 and 2 illustrate the preferred embodiment of a system for dyeing a strip-like artificial rattan 1 according to the present invention. The system includes: a feed spool 2 having a mandrel 21 with the artificial rattan 1 wound thereon for supplying the artificial rattan 1; a product spool 3 having a mandrel 31 for taking up and storing the artificial rattan 1; a dyeing unit 5 including a dyeing bath 51 for dyeing the artificial rattan 1 with a dye material; a rubbing member 6 disposed downstream of the dyeing unit 5 for rubbing uniformly the dye material on the artificial rattan 1; a drying unit 7 disposed downstream of the rubbing member 6 for drying the dye material on the artificial rattan 1; and a conveying unit 4 for drawing the artificial rattan 1 from the feed spool 2, transporting the artificial rattan 1 to pass through the dyeing unit 5, the rubbing member 6, and the drying unit 7, and delivering the dyed artificial rattan 1 to the product spool 3.

In this embodiment, the conveying unit 4 includes a pair of first pulling rollers 411 disposed downstream of the feed spool 2 and upstream of the dyeing unit 5, and a pair of second pulling rollers 421 disposed downstream of the drying unit 7 and upstream of the product spool 3.

The system further includes a first pressing member 52 mounted on the dyeing bath 51, and a second pressing member 56 mounted on the dyeing bath 51 and disposed downstream of the first pressing member 52. The first and second pressing members 52, 56 press the artificial rattan 1 into the dyeing bath 51. Each of the first and second pressing members 52, 56 includes a pressing roller 521 (561) that presses the artificial rattan 1 and that is adjustable in depth in the dyeing bath 51 through connection with a screw rod 522 (562).

The system further includes a first supporting roller 53 mounted on a front end of the dyeing bath 51 and disposed upstream of and above the pressing roller 521 of the first pressing member 52, and a second supporting roller 57 mounted on a rear end of the dyeing bath 51 and disposed downstream of and above the pressing roller 561 of the second pressing member 56.

The rubbing member 6 is mounted on the rear end of the dyeing bath 51, and includes upper and lower rubbing pads 611, 612 that cooperatively define a nip 613 for passage of the artificial rattan 1 therethrough. The rubbing pads 611, 612 are preferably made from sponge or cloth. A distance between the upper and lower rubbing pads 611, 612 is adjustable through connection between the upper rubbing pad 611 and a screw rod 62.

The system further includes a pair of adjusting rollers 54 disposed downstream of the rubbing member 6 and upstream of the drying unit 7 and adjustable in height for adjusting the height of the artificial rattan 1 to correspond to that of an entrance 70 of the drying unit 7 before entering into the drying unit 7.

The drying unit includes a housing 71, two electrical heaters 72 mounted in the housing 71, and three fans 73 mounted on the housing 71 for accelerating drying of the dye material on the artificial rattan 1 passing therethrough.

By passing the artificial rattan 1 through the dyeing bath 51 and the drying unit 7 of the system of this invention, the aforesaid drawbacks associated with the prior art can be considerably alleviated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system for dyeing an artificial rattan, comprising:
a feed spool for supplying the artificial rattan;
a product spool for storing the artificial rattan;
a dyeing unit including a dyeing bath for dyeing the artificial rattan with a dye material;
a rubbing member disposed downstream of said dyeing unit for rubbing uniformly the dye material on the artificial rattan;
a drying unit disposed downstream of said rubbing member for drying the dye material on the artificial rattan; and
a conveying unit for drawing the artificial rattan from said feed spool, transporting the artificial rattan to pass through said dyeing unit, said rubbing member, and said drying unit, and delivering the dyed artificial rattan to said product spool.

2. The system as claimed in claim 1, wherein said conveying unit includes a pair of first pulling rollers disposed downstream of said feed spool and upstream of said dyeing unit, and a pair of second pulling rollers disposed downstream of said drying unit and upstream of said product spool.

3. The system as claimed in claim 2, further comprising a first pressing member mounted on said dyeing bath, and a second pressing member mounted on said dyeing bath and disposed downstream of said first pressing member, said first and second pressing members pressing the artificial rattan into the dyeing bath.

4. The system as claimed in claim 3, wherein each of said first and second pressing members includes a pressing roller that presses the artificial rattan and that is adjustable in depth in said dyeing bath.

5. The system as claimed in claim 4, further comprising a first supporting roller mounted on said dyeing bath and disposed upstream of and above said pressing roller of said first pressing member, and a second supporting roller mounted on said dyeing bath and disposed downstream of and above said pressing roller of said second pressing member.

6. The system as claimed in claim 1, wherein said rubbing member is mounted on said dyeing bath and includes upper and lower rubbing pads that cooperatively define a nip for passage of the artificial rattan therethrough.

7. The system as claimed in claim 6, wherein a distance between said upper and lower rubbing pads is adjustable.

8. The system as claimed in claim 1, further comprising a pair of adjusting rollers disposed downstream of said rubbing member and upstream of said drying unit and adjustable in height for adjusting the height of the artificial rattan to correspond to that of an entrance of said drying unit before entering into said drying unit.
